(19) United States
(12) Patent Application Publication
(10) Pub. No.: US 2002/0121243 A1
(43) Pub. Date: Sep. 5, 2002

(54) Petscape

(76) Inventor: Glenn Joseph Martyn, Orlando, FL (US)

Correspondence Address: Glenn J. Martyn, 3414 Cambay Ave, Orlando, FL, 32817, US

(21) Appl. No.: 09/945,501

(22) Filed: Dec. 4, 2001

Related U.S. Application Data
(60) Provisional application No. 60/230,046, filed on Sep. 1, 2000.

(51) Int. Cl. A01K 29/00

(52) U.S. Cl. 119/28.5

(57) ABSTRACT

A collection of three (3) pet products that each serve as functional utility for animals; a first (1^{st}) product of which is specifically meant for cats and could be either a real tree or a simulated tree and used as a resting area and scratching post, having real or simulated leaves, having one or more padded platforms for perching, and having rope wrapped around one or more portions of said tree; a second (2^{nd}) product which is meant for a combination of animals and could be used as a one (1), two (2), or three (3) piece litter box or a bed/rest area, having stairs 7.5 cm (3 inches) to 25 cm (10 inches) in height which enables animal to step up the stairs and get a look at where they want to go before stepping into box, and stairs and box could be as one (1) piece or stairs could be a separate piece than box; and a third (3^{rd}) product which is meant for a combination of animals and could be used by animals to eat and drink from, being made from real rocks or stones or simulated rocks or stones, requiring a device for circulating water, and having one (1) or more bowls which could be used to put pet food in, decorative plants or trees, or any other type decoration into the one (1) or more bowls.

### CROSS-REFERENCE TO RELATED APPLICATION U.S. PATENT DOCUMENTS

U.S. Pat. No. 5,054,429 10/1991 Bradford . . . 119/29

U.S. Pat. No. 5,188,063 2/1993 Evans . . . 119/165

U.S. Pat. No. 5,730,084 3/1998 Kacic . . . 119/165

U.S. Pat. No. 5,394,835 3/1995 Gatta . . . 119/170

U.S. Pat. No. 5,329,876 7/1994 Tracy . . . 119/51.03

### FIELD OF ENDEAVER

This invention relates to the main three (3) functional utilities generally used by domestic cats such as; first (1^{st}) scratching post devices, second (2^{nd}) litter box's or beds/rest areas (can used by animals other than cats), and third (3^{rd}) food and water devices (can used by animals other than cats).

### BACKGROUND OF THE INVENTION

Scratching post devices are extremely beneficial to cats when they need to scratch their claws or climb on something other than their masters furniture, while litter box's or beds are both very special and important place that an animal spends time in, and often a place that is pondered at, looked at, and sniffed at by any animal that goes there but usually they don't have a way to provide animals that good look, and weather it is a bowl, a saucer, or some other device, food and water products are the most important of them all and are usually easy to kick over and water becomes more prone to bacteria the longer the said water remains stagnate.

U.S. Pat. No. 5,054,429, discloses a cat scratching post and method for making a cat scratching post for cats which has an undulating configuration formed by portions of carpeting disposed in a spaced relationship from an underlying base member. This said invention is said to resemble a tree, yet it has no real or simulated branches with twigs and leaves, only carpet surrounding a wood frame attempting to take on the shape of a tree which it does not, but instead it simply looks like what it is, a post wrapped in carpet; furthermore, the carpet will ware out within 5 years from hair, rips and tears, and being compressed causing the owner to have to dispose of the unit or ship the fairly large unit back to the factory that made it to be refinished.

U.S. Pat. No. 5,188,063, discloses a combination simulated planter and cat litter enclosure comprising a simulated planter having a false bottom portion with an opening leading therein for receiving cat litter in the bottom portion, and is to have a planter looking bottom like that of a pot for a plant or tree, yet most cats do not like to stay around the litter box after they use it; and therefore it is highly unlikely that any cats would use the simulated planter/litter box and scratching post or anything else other than a litter box.

U.S. Pat. No. 5,730,084, discloses a litter box for domestic cats or other domestic mammals which has interior surfaces that are abrasive and that dull the claws of a cat when it uses the litter box, and for people who don't use a bag to line there cats litter box this might work great, but it would be obsolete for those who do use a bag to line there cats litter box.

U.S. Pat. No. 5,394,835, discloses a pet sanitation station that comprises a housing having a main chamber a sliding plate forming a chamber floor located in a collar which sits on a receptacle for collecting soiled litter, and whereas this mechanical device, which has tall and steep non-functional stairs that most cats would hop over to get in the litter box if they would even use it; because most cats get scared from sudden and drastic movements and/or noise made by mechanical devices and therefore most cats would probably not want to use this invention, and furthermore, this invention wastes litter by dumping it all at once, whereas, most people use litter that will last as long as possible by scooping out the litter that is soiled while leaving the litter that is not soiled in the litter box.

U.S. Pat. No. 5,329,876, discloses an animal watering apparatus including a dish including a dish covered with a lid that includes an opening with a wheel that is rotatably mounted to the lid in an upright orientation and extends above the lid through the opening and into the dish to a position near the bottom surface of the dish with the outer circumferential surface of the wheel covered with projections or ridges which efficiently bring water out of the dish as the wheel rotates as a result of being licked by the animal; and although an interesting concept it is meant only for drinking water and resembles a box with a wheel sticking out of it.

### BRIEF SUMMARY OF THE INVENTION

The first (1^{st}) of our three (3) main functional utilities generally used by domestic cats is the invention of “A CAT/FELINE TREE AND SCRATCHING POST” which can be either a real tree or a simulated tree with an actual real or simulated trunk, real or simulated branches and real or simulated leaves that cats enjoy rubbing their whiskers against, having one or more platforms for perching and resting on with padding which can be carpet or some other comfortable padding that can be easily replaced when worn out, and having rope wrapped around one or more portions of said tree for cats to scratch their claws on that can easily be replaced when worn out; unlike U.S. Pat. No. 5,054,429, which is just a wood frame wrapped in carpet that will ware out and it is not a real tree and it does not resemble a real tree and it does not have rope which cats like to scratch on much more than carpet.

The second (2^{nd}) of our three (3) main functional utilities generally used by domestic cats, that could also be used by animals other than cats, is the invention of “A ONE (1), TWO (2), OR THREE (3) PIECE LITTER BOX OR BED/RESTING AREA”, having stairs 7.5 cm (3 inches) to 25 cm (10 inches) in height which enables animal to step up the stairs and to get a look at where they want to go before stepping into box and are usually close to seven (7) inches high which is a more common height for litter box's in regards to the size of the average domestic cat, and stairs and box could be as one (1) piece or stairs could be a separate piece than the bottom box portion, and being made from real rock/stone panels or slabs or simulated rock panels or slabs that would have a jagged texture like that of real rock/stone panels or slabs and is otherwise a basic litter box that could be used as a bed/rest area that has no mechanical aspect to it and can use low cost scoopable litter if used as a litter box; unlike U.S. Pat. No. 5,394,835, which has tall and steep non-functional stairs that most cats would hop over to get in the litter box if they would even use it; because most cats get scared from sudden and drastic movements and/or noise made by mechanical devices and therefore most cats would probably not want to use this invention, and furthermore, this invention wastes litter by dumping it all at once, whereas, most people use litter that will last as long as possible by scooping out the litter that is soiled while leaving the litter that is not soiled in the litter box.

The third (3^{rd}) of three (3) main functional utilities generally used by domestic cats that could also be used by animals other than cats, is the invention of “WATERFALL WITH BOWLS USED FOR PET FOOD OR DECORATIONS”, having a water basin that animals can drink from that has a submerged water pump or inline water pump or some other devices that keeps circulating the water from the water basin up and down a waterfall system and back into the basin again, being made from real rocks or stones or simulated rocks or stones, and having one (1) or more bowls which could be used to put pet food into for animals to eat or to put decorative plants or trees, or any other type decoration into the one (1) or more bowls and rather use the waterfall as a decoration even where there are not any animals to use it.

### BRIEF DESCRIPTION OF THE SEVERAL VIEWS OF THE DRAWING

FIG. 1A is a front perspective view of the invention of a “CAT/FELINE TREE AND SCRATCHING POST” which can be either a real tree or a simulated tree.

FIG. 1B is a front perspective view of the invention of a ONE (1), TWO (2), OR THREE (3) PIECE “LITTER BOX OR BED/RESTING AREA”, having stairs 7.5 cm (3 inches) to 25 cm (10 inches) in height which enables animal to step up the stairs and to get a look at where they want to go before stepping into box.

FIG. 1C is a front perspective view of the invention of a “WATERFALL WITH BOWLS USED FOR PET FOOD OR DECORATIONS”, having a water basin that animals can drink from and one (1) or more bowls which animals can eat food from.

FIG. 2 is a front perspective view of the invention of a “CAT/FELINE TREE AND SCRATCHING POST” which can be either a real tree or a simulated tree.

FIG. 3A is a front perspective view of the invention of a “CAT/FELINE TREE AND SCRATCHING POST” which can be either a real tree or a simulated tree, that has only one platform with padding.

FIG. 3B is a front perspective view of the invention of a “CAT/FELINE TREE AND SCRATCHING POST” which can be either a real tree or a simulated tree, that has more than one (1) platform with padding.

FIG. 4A is a front perspective view of the invention of a “CAT/FELINE TREE AND SCRATCHING POST” which can be either a real tree or a simulated tree, that explains different parts of the tree and what functional aspect each part serves.

FIG. 4B is a front perspective view of the invention of a “CAT/FELINE TREE AND SCRATCHING POST” which can be either a real tree or a simulated tree, that explains different parts of the tree and what functional aspect each part serves.

FIG. 5A is a front perspective view of the invention of a “CAT/FELINE TREE AND SCRATCHING POST” which can be either a real tree or a simulated tree, that explains different parts of the tree and what functional aspect each part serves.

FIG. 5B is a side perspective view of the invention of a “CAT/FELINE TREE AND SCRATCHING POST” which can be either a real tree or a simulated tree, that explains different parts of the tree and what functional aspect each part serves.

FIG. 6A is a front perspective view of the invention of a “LITTER BOX OR BED/RESTING AREA”, having stairs 7.5 cm (3 inches) to 25 cm (10 inches) in height which enables animal to step up the stairs and to get a look at where they want to go before stepping into box.

FIG. 6B is a front perspective view of the invention of the top piece of a “LITTER BOX OR BED/RESTING AREA”, having stairs 7.5 cm (3 inches) to 25 cm (10 inches) in height which enables animal to step up the stairs and to get a look at where they want to go before stepping into box.

FIG. 6C is a front perspective view of the invention of the bottom piece of a “LITTER BOX OR BED/RESTING AREA”, having stairs 7.5 cm (3 inches) to 25 cm (10 inches) in height which enables animal to step up the stairs and to get a look at where they want to go before stepping into box.

FIG. 7A is a side perspective and transparent view of the invention “LITTER BOX OR BED/RESTING AREA”, having stairs 7.5 cm (3 inches) to 25 cm (10 inches) in height, with a cat stepping up the stairs demonstrating how the stairs enables animal to step up the stairs and to get a look at where they want to go before stepping into box.

FIG. 7B is a side perspective and transparent view of the invention “LITTER BOX OR BED/RESTING AREA”, having stairs 7.5 cm (3 inches) to 25 cm (10 inches) in height, with the top piece and the bottom piece being separated to show that it can be a two (2) piece unit.

FIG. 7C is a side perspective and transparent view of the invention “LITTER BOX OR BED/RESTING AREA”, having stairs 7.5 cm (3 inches) to 25 cm (10 inches) in height, with the top piece and the bottom piece being separated to show that it can be a three (3) piece unit.

FIG. 7D is a side perspective and transparent view of the invention “LITTER BOX OR BED/RESTING AREA”, having stairs 7.5 cm (3 inches) to 25 cm (10 inches) in height, with the top piece and the bottom piece being separated to show that it can be a one (1) piece unit.

FIG. 7E is a front perspective view of the invention “LITTER BOX OR BED/RESTING AREA”, having stairs 7.5 cm (3 inches) to 25 cm (10 inches) in height, with the top piece and the bottom piece being separated to show the invention as a complete one (1) or two (2) piece unit.

FIG. 8 is a front perspective view of the invention of a “WATERFALL WITH BOWLS USED FOR PET FOOD OR DECORATIONS”, having a water basin that animals can drink from and one (1) or more bowls which animals can eat food from.

FIG. 9A is a front perspective and transparent view of the invention of a “WATERFALL WITH BOWLS USED FOR PET FOOD OR DECORATIONS”, having a water basin that animals can drink from and one (1) or more bowls which animals can eat food from, which also shows a view of the water pump and how units parts are combined.

FIG. 9B is a side perspective and transparent view of the invention of a “WATERFALL WITH BOWLS USED FOR PET FOOD OR DECORATIONS”, having a water basin that animals can drink from and one (1) or more bowls which animals can eat food from, which also shows a view of the water pump and how units parts are combined.

FIG. 9C is a front perspective view of the invention of a “WATERFALL WITH BOWLS USED FOR PET FOOD OR DECORATIONS”, having a water basin that animals can drink from and one (1) or more bowls which animals can eat food from, which also shows how unit's parts are combined.

FIG. 9D is a front perspective view of the invention of a “WATERFALL WITH BOWLS USED FOR PET FOOD OR DECORATIONS”, having a water basin that animals can drink from and one (1) or more bowls which animals can eat food from, which also shows a view of cat eating food from “a bowl” next to water basin.

FIG. 9E is a front perspective view of the invention of a “WATERFALL WITH BOWLS USED FOR PET FOOD OR DECORATIONS”, having a water basin that animals can drink from and one (1) or more bowls which animals can eat food from, which also shows a view of cat eating drinking from “the water basin”.

FIG. 10A is a front perspective view of the invention of a “WATERFALL WITH BOWLS USED FOR PET FOOD OR DECORATIONS”, having a water basin that animals can drink from and one (1) or more bowls which animals can eat food from, which also shows a unit that has more than “one (1) bowl” next to water basin.

FIG. 10B is a front perspective view of the invention of a “WATERFALL WITH BOWLS USED FOR PET FOOD OR DECORATIONS”, having a water basin that animals can drink from and one (1) or more bowls which animals can eat food from, which shows the top piece of a unit that has more than one (1) bowl next to water basin.

FIG. 11A is a front perspective view of the invention of a “WATERFALL WITH BOWLS USED FOR PET FOOD OR DECORATIONS”, having a water basin that animals can drink from and one (1) or more bowls which animals can eat food from, which shows cats interacting with unit and various components of the unit being used by cats.

FIG. 11B is a front perspective view of the invention of a “WATERFALL WITH BOWLS USED FOR PET FOOD OR DECORATIONS”, having a water basin that animals can drink from and one (1) or more bowls which animals can eat food from, which shows cats interacting with unit and various components of the unit being used by cats.

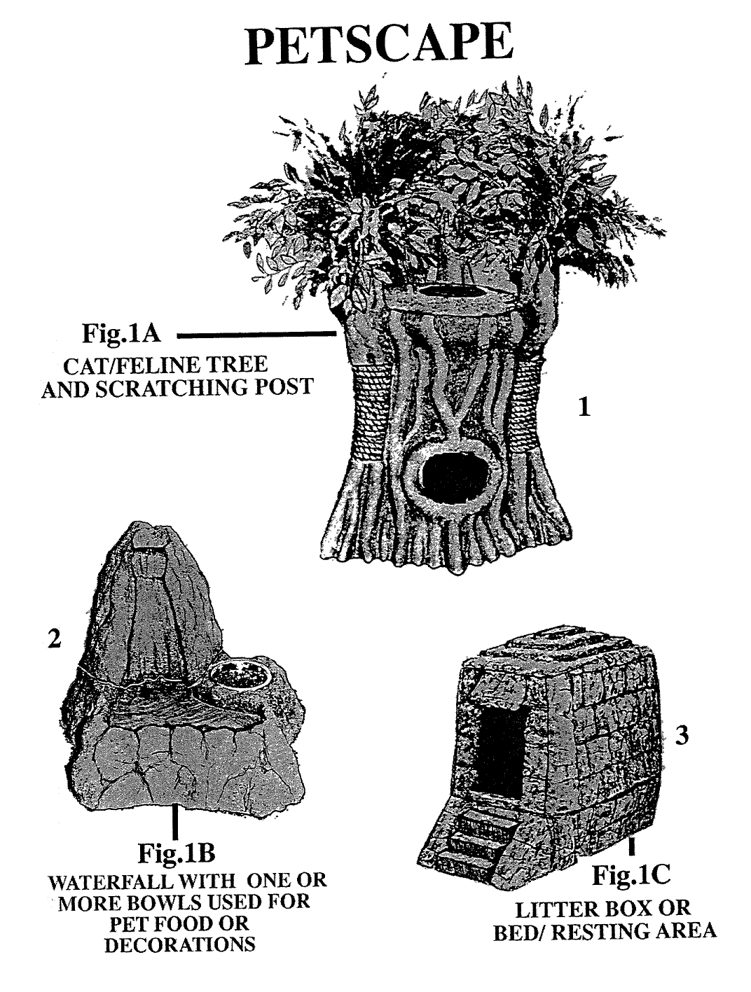

### DETAILED DESCRIPTION OF THE INVENTION

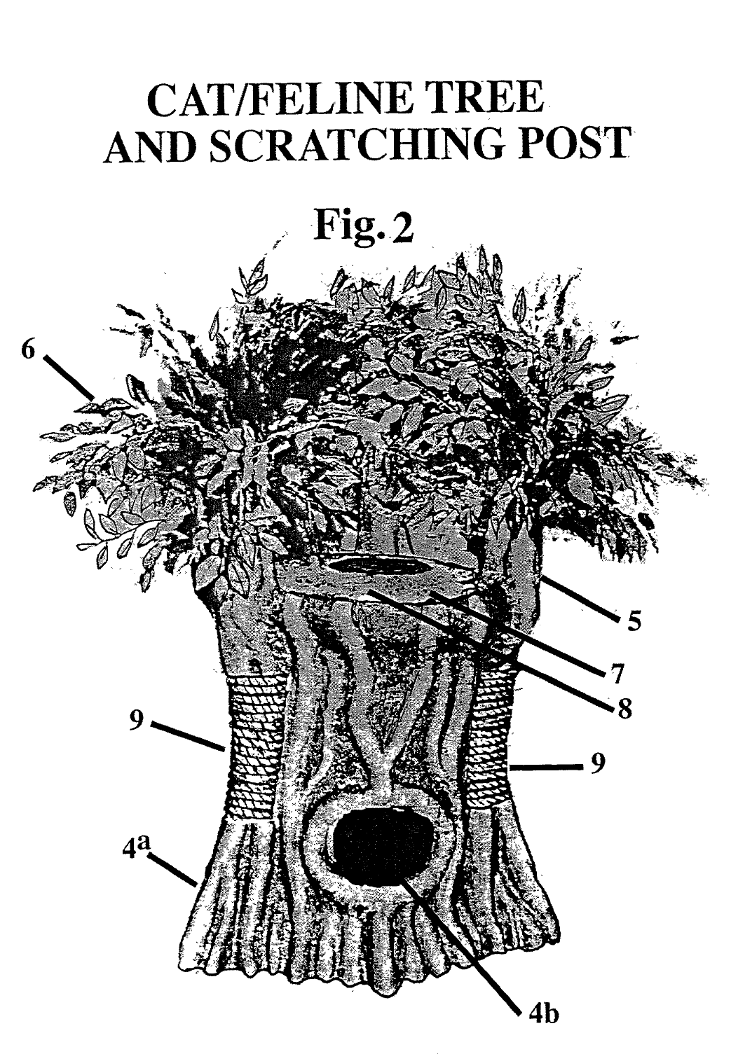

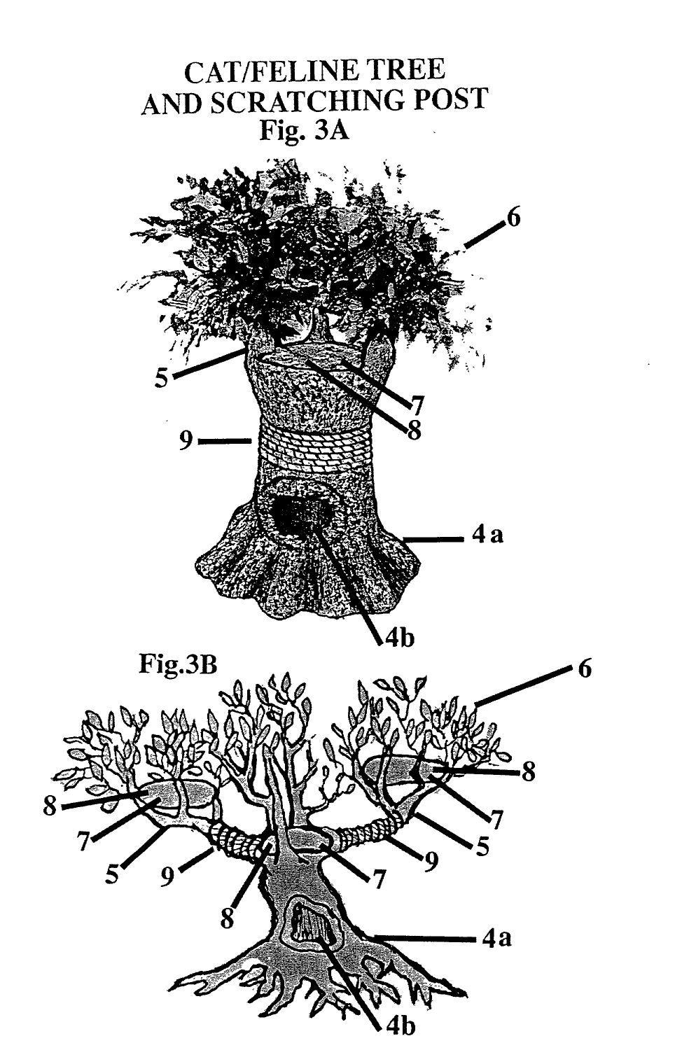

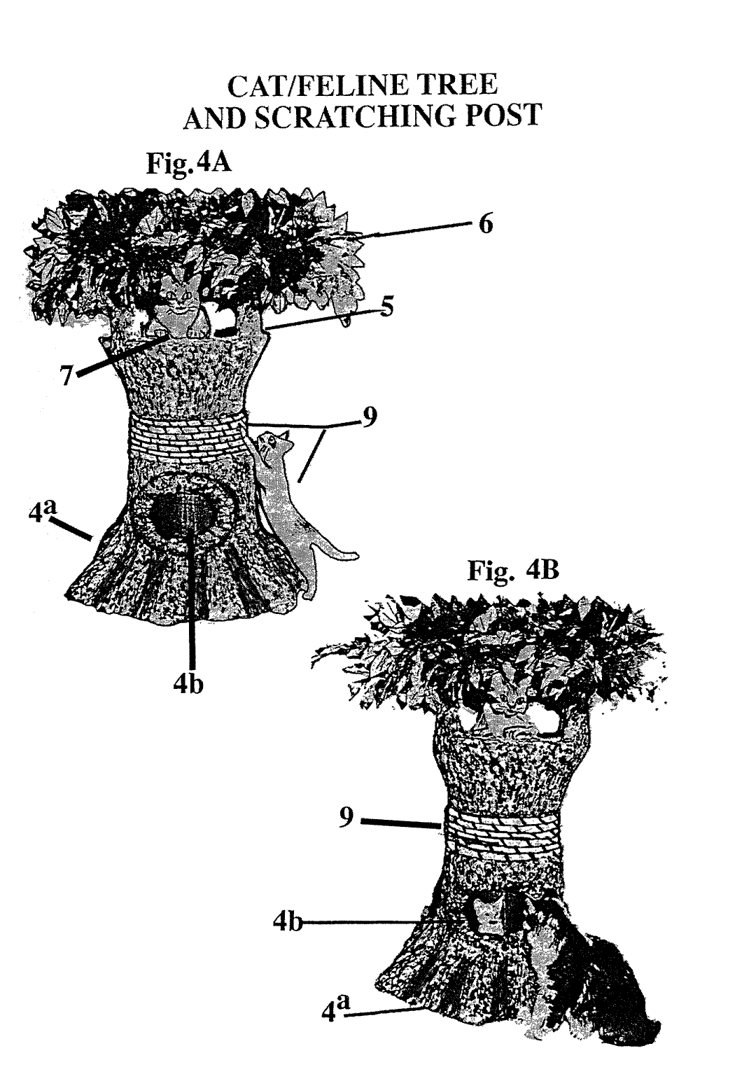

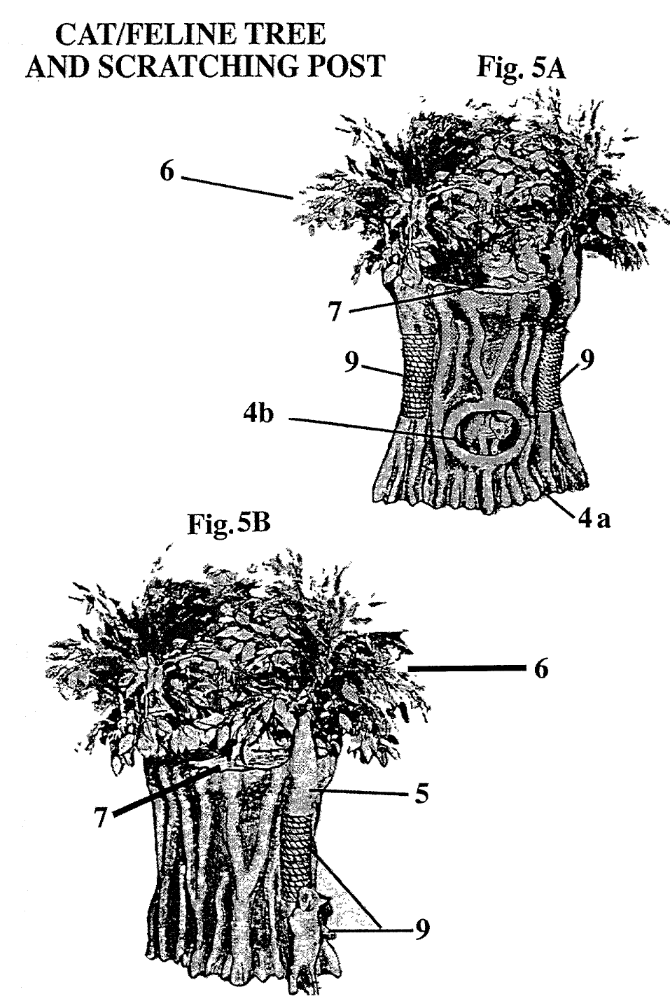

FIG. 2 through FIG. 5B demonstrate how the “CAT/FELINE TREE AND SCRATCHING POST” is functional. This invention can be sculpted using a variety of common sculpting materials and techniques on an individual unit by unit production method, and it can also be made from a real tree and/or real tree branches or other materials, or molded and replicated through a wide variety of production methods. Number four (4) which is shown in FIG. 2 through FIG. 5B is the trunk portion of the tree. Number five (5) which is shown in FIG. 2 through FIG. 5B are the real or simulated branches of the tree. Number six (6) which is shown in FIG. 2 through FIG. 5B are the real or simulated leaves of the tree. Number seven (7) which is shown in FIG. 2 through FIG. 5B are the one (1) or more platforms in, on, or part of the tree. Number eight (8) which is shown in FIG. 2 through FIG. 5B is the padding which could be carpet or any other comfortable padding that covers or rests on the platforms in, on, or part of the tree. Number nine (9) which is shown in FIG. 2 through FIG. 5B is the rope which wraps around portions of the tree.

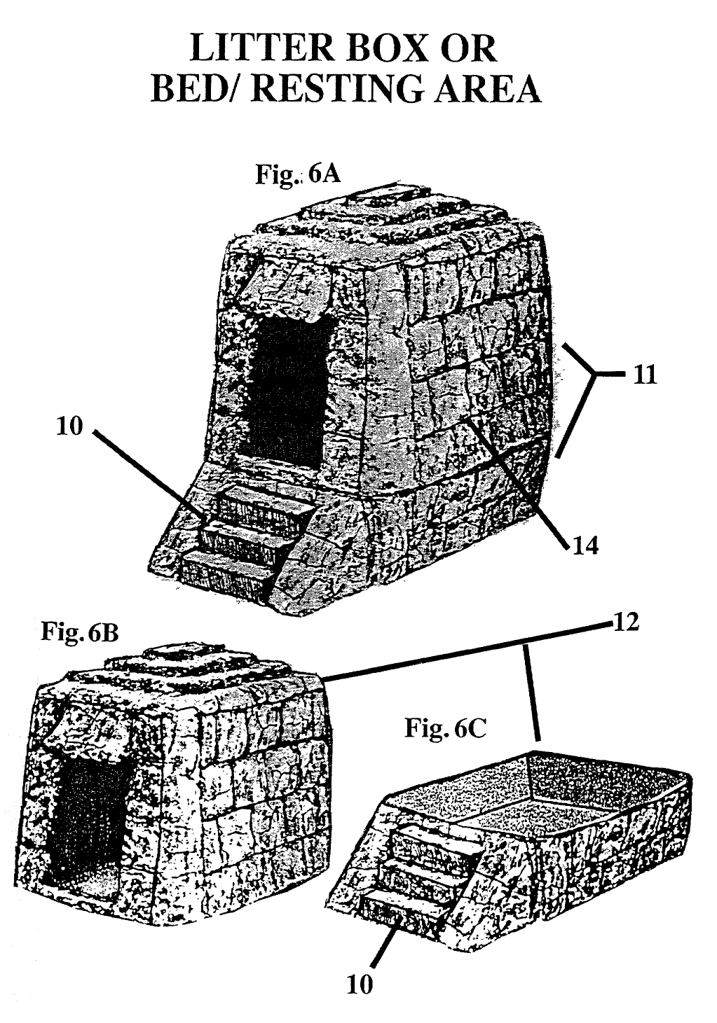

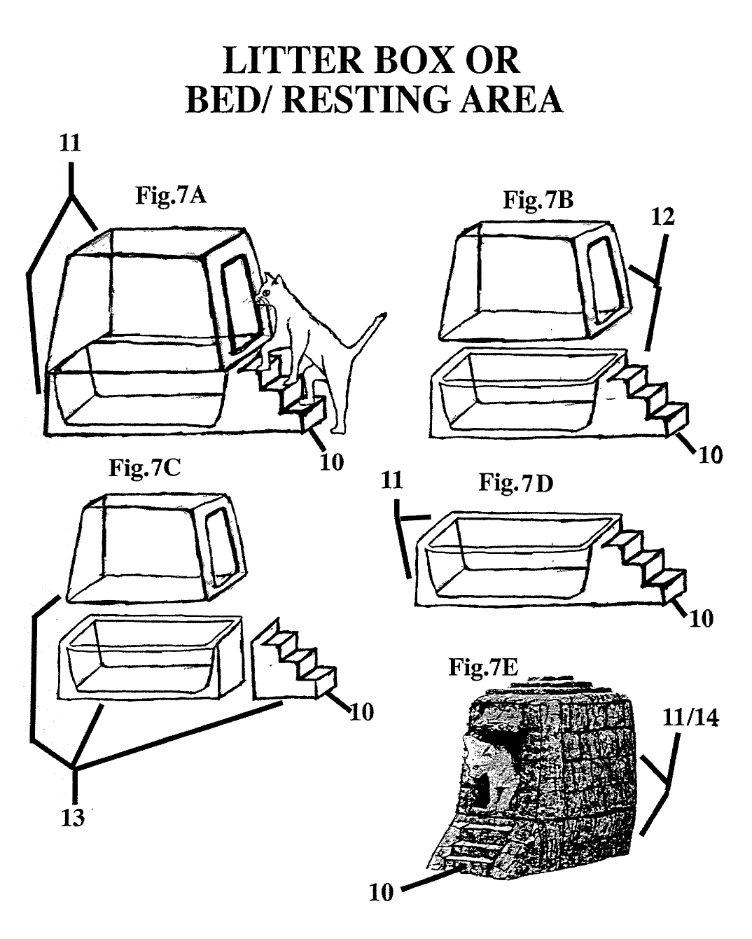

FIG. 6A through FIG. 7E demonstrate how the “LITTER BOX OR BED/RESTING AREA” is functional. This invention can be sculpted using a variety of common sculpting materials and techniques on an individual unit by unit production method, such as from wood, real or simulated rock or stone or other materials, or molded and replicated through a wide variety of production methods. Number ten (10) which is shown in FIG. 6A through FIG. 7E are the stairs 7.5 cm (3 inches) to 25 cm (10 inches) in height which enables animal to step up the stairs and to get a look at where they want to go before stepping into box. Number eleven (11) which is shown in FIG. 6A through FIG. 7E is the invention shown as a single/one (1) piece unit. Number twelve (12) which is shown in FIG. 6A through FIG. 7E is the invention shown as a two (2) piece unit. Number thirteen (13) which is shown in FIG.6A through FIG.7E is the invention shown as a three (3) piece unit.

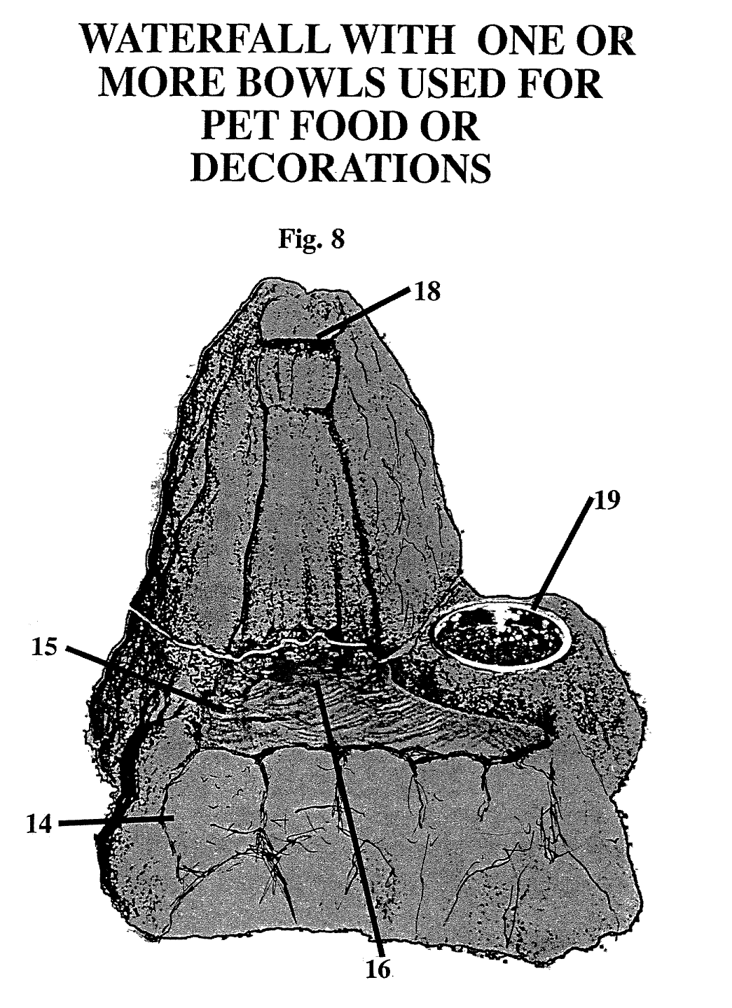

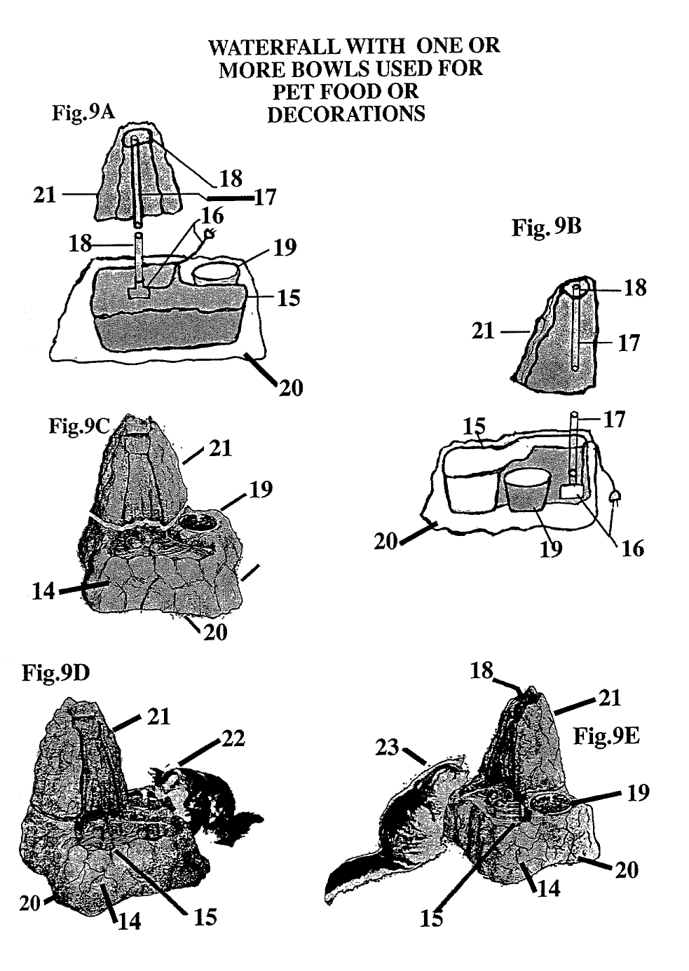

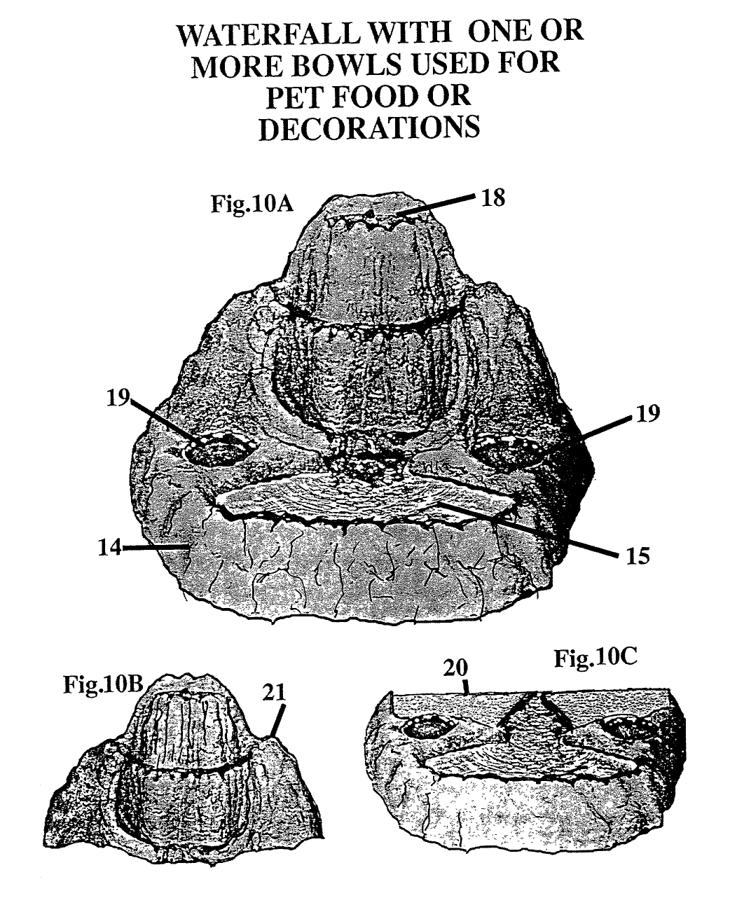

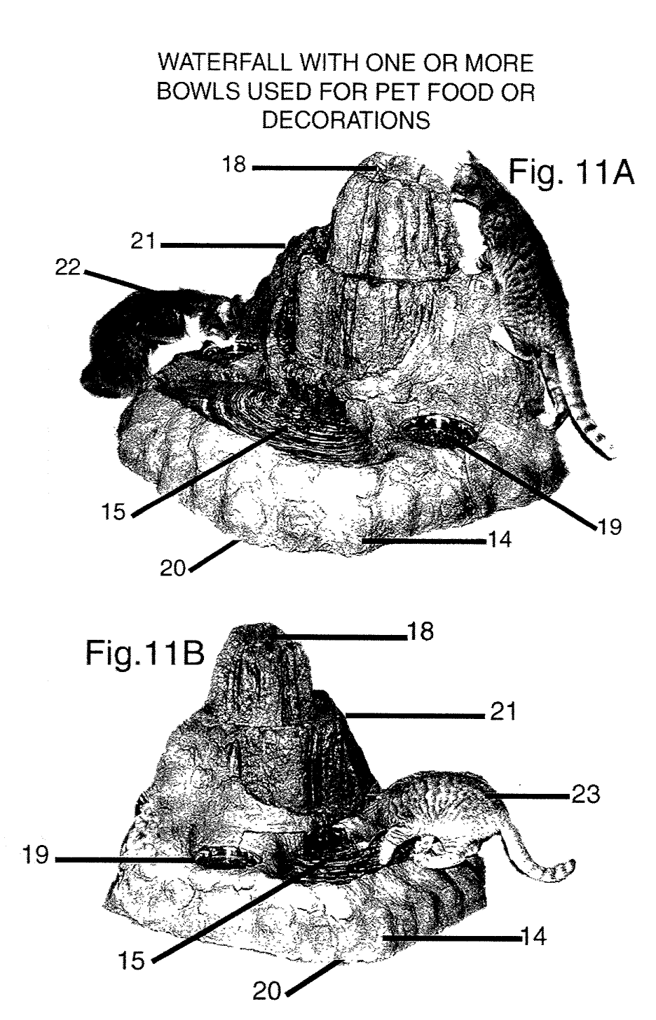

FIG.8 through FIG. 11B demonstrate how the of “WATERFALL WITH BOWLS USED FOR PET FOOD OR DECORATIONS” is functional. This invention can be sculpted using a variety of common sculpting materials and techniques on an individual unit by unit production method, such as from wood, real or simulated rock or stone or other materials, or molded and replicated through a wide variety of production methods. Number fourteen (14) which is shown in FIG. 8 through FIG. 11B is an example of one of textures this invention will have. Number fifteen (15) which is shown in FIG. 8 through FIG. 11B is the water basin which is where the animals will drink water from or those without animals will simply visually see the water flow into as it circulates. Number sixteen (16) which is shown in FIG. 8 through FIG. 11B is an example of the water pump and how it will be incorporated into this invention. Number seventeen (17) which is shown in FIG. 8 through FIG. 11B is an example of the water pump line and how it will be incorporated into this invention. Number eighteen (18) which is shown in FIG. 8 through FIG. 11B is an example of where the water pump line, incorporated into this invention, allows the water to flow out and back down the waterfall. Number nineteen (19) which is shown in FIG. 8 through FIG. 11B shows the one (1) or more bowls and how they will be incorporated into this invention. Number twenty (20) which is shown in FIG. 8 through FIG. 11B is an example of the bottom portion of the unit, and how it will be incorporated into this invention. Number twenty one (21) which is shown in FIG. 8 through FIG. 11B is an example of the top portion of the unit, and how it will be incorporated into this invention. Number twenty two (22) which is shown in FIG. 8 through FIG. 11B shows an example of a cat eating food from said bowl (19), and how it will be incorporated into this invention. Number twenty three (23) which is shown in FIG. 8 through FIG. 11B shows an example of a cat drinking water from said water basin (15), and how it will be incorporated into this invention. Number twenty four (24) which is shown in FIG. 11A, shows an example of a cat climbing said invention (2), and how it will be incorporated into this invention.

A collection of three (3) pet products that each serve as functional utility for animals.

What I claim as my invention is:

1. “CAT/FELINE TREE AND SCRATCHING POST” product of which can be used by cats and other animals and comprised of:
a real tree;
a simulated tree;
used as a resting area and scratching post;
having real leaves, which cats love to rub their whiskers against;
having simulated leaves, which cats love to rub their whiskers against;
having one or more padded platforms for cats to perch on;
having rope wrapped around one or more portions of said tree for cats to scratch their claws on.

2. “LITTER BOX OR BED/RESTING AREA” product of which can be used by cats and other animals and comprised of:
a one (1), two (2), or three (3) piece litter box or a bed/rest area;
having stairs 7.5 cm (3 inches) to 25 cm (10 inches) in height which enables animal to step up the stairs and get a look at where they want to go before stepping into box;
stairs and box portion that could be as one (1) piece;
stairs and box portion that could be a separate pieces from one another.

3. “WATERFALL WITH BOWLS USED FOR PET FOOD OR DECORATIONS” product of which cats and other animals can use and is comprised of:
a water basin for animals to drink from;
having one (1) or more bowls which could be used for pet food for animals to eat;
having one (1) or more bowls which could be used for decorative plants or trees, or any other type decoration into when there is not any animals to use it;
being made from real rocks or stones or simulated rocks or stones;
requiring a water pump or other device for circulating water.
